(19) United States
(12) Patent Application Publication
(10) Pub. No.: US 2008/0055217 A1
(43) Pub. Date: Mar. 6, 2008

(54) Method for driving liquid crystal display device

(75) Inventors: Tsung-Ping Liao, Miao-Li (TW); Wen-Kai Lo, Miao-Li (TW); Chien-Jen Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/899,183

(22) Filed: Sep. 4, 2007

(30) Foreign Application Priority Data
Sep. 1, 2006 (TW) 95132394

(51) Int. Cl. G09G 3/36

(52) U.S. Cl. 345/87

(57) ABSTRACT

A method for driving a liquid crystal display device (20) is provided. The liquid crystal display device comprising a plurality of scanning lines (201), a plurality of data lines (202), a scanning driving circuit (210) for providing scanning signals to the scanning lines, a data driving circuit (220) for providing data signals to the data lines, and a light emitting diode matrix (240) for emitting red, green and blue light beams. The method comprising: dividing a frame time into three sub-frame times (t1, t3, and t5) and three blanking periods (t2, t4, and t6), each of the blanking periods following a respective one of the three sub-frame times; during the three sub-frame times, the light emitting diode matrix emitting red, green, and blue light beams, respectively; during at least one of the three blanking periods, the light emitting diode matrix emitting red, green, and blue light beams simultaneously.

### FIELD OF THE INVENTION

The present invention relates to methods for driving liquid crystal display (LCD) devices, and particularly to a method for driving an LCD device so as to enhance a brightness of a display of the LCD device.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace cathode ray tube (CRT) monitors and televisions.

FIG. 3 is an abbreviated circuit diagram of a typical LCD device. The LCD device 10 includes n rows of parallel scanning lines 101 (where n is a natural number), m columns of parallel data lines 102 orthogonal to the n rows of parallel scanning lines 101 (where m is also a natural number), a plurality of pixels 105 defined by the crossing scanning lines 101 and data lines 102, a scanning driving circuit 110 for providing scanning signals to the scanning lines 101, a data driving circuit 120 for providing data signals to the data lines 102, and a light emitting diode (LED) matrix 140 for illuminating the LCD device 10.

The LED matrix 140 includes a plurality of red LEDs 141, a plurality of green LEDs 142, and a plurality of blue LEDs 143. The red LEDs 141, the green LEDs 142, and the blue LEDs 143 are alternately arranged in line. A pitch between successive red LEDs 141 is constant. A pitch between successive green LEDs 142 is constant. A pitch between successive blue LEDs 143 is constant.

FIG. 4 shows timing charts illustrating operation of the LCD device 10. Graph (R) illustrates a waveform diagram of voltage supplied to the red LEDs 141. Graph (G) illustrates a waveform diagram of voltage supplied to the green LEDs 142. Graph (B) illustrates a waveform diagram of voltage supplied to the blue LEDs 143. Graphs (G₁-Gₙ) illustrate waveform diagrams of voltage supplied to the scanning lines 101. Graph (V_{d}) illustrates a waveform diagram of gradation voltage corresponding to the image data supplied to the data lines 102. A period of time for displaying a full-color image is defined as a frame time.

The operation of the LCD device 10 includes the following steps:

a. a frame time is divided into three sub-frame times t₁, t₃, and t₅, and three blanking periods t₂, t₄, and t₆. Each of the blanking periods t₂, t₄, and t₆ follows one of the three sub-frame times t₁, t₃, and t₅, respectively.

b. during the first sub-frame time t₁, a voltage pulse “on” is provided to the red LEDs 141 of the LED matrix 140, so that the red LEDs 141 are turned on and start emitting red light beams for image display.

c. when the red LEDs 141 are turned on, the scanning driving circuit 110 sequentially provides a plurality of scanning signals 151 to the scanning lines 101 to enable the pixels 105 to receive data signals.

d. when the scanning lines 101 are scanned, the data driving circuit 120 outputs the gradation voltage V_{d} to the data lines 102, then the pixels 105 receive data signals from corresponding data lines 102 to cooperatively display a red sub-image.

e. during the first blanking period t₂, a voltage pulse “off” is provided to the red LEDs 141, so that the red LEDs 141 are turned off and stop emitting red light beams. Simultaneously, no scanning signals or data signals are applied to the scanning lines 101 or the data lines 102. Accordingly, the pixels 105 discharge electricity so as to eliminate the so-called residual image phenomenon.

f. during the second sub-frame time t₃, a voltage pulse “on” is provided to the green LEDs 142 of the LED matrix 140, so that the green LEDs 142 are turned on and start emitting green light for image display.

g. steps “c” through “e” are repeated in respect of the green LEDs 142, in order to display a green sub-image. However, the second blanking period t₄ replaces the first blanking period t₂.

h. during the third sub-frame time t₅, a voltage pulse “on” is provided to the blue LEDs 143 of the LED matrix 140, so that the blue LEDs 143 are turned on and start emitting blue light for image display.

i. steps “c” through “e” are repeated in respect of the blue LEDs 143, in order to display a blue sub-image. However, the third blanking period t₆ replaces the first blanking period t₂. Then the red sub-image, the green sub-image, and the blue sub-image mix and form a full-color image, as perceived by a human viewer.

j. in the next frame time, steps “a” through “i” are repeated.

Generally, the total amount of LEDs 141, 142, 143 of the LED matrix 140 is limited. This means the intensity of illumination sequentially generated by the red LEDs 141, the green LEDs 142, and the blue LEDs 143 may be somewhat low. Accordingly, particularly when a brighter image is desired, the brightness of the LCD device 10 may be considered unsatisfactory.

Accordingly, what is needed is a method for driving an LCD device that can overcome the above-described deficiencies.

### SUMMARY

One aspect of a method for driving a liquid crystal display device is provided. The liquid crystal display device comprising a plurality of scanning lines, a plurality of data lines orthogonal to the scanning lines, a scanning driving circuit configured for providing scanning signals to the scanning lines, a data driving circuit configured for providing data signals to the data lines, and a light emitting diode matrix configured for emitting red, green and blue light beams. The method comprising: dividing a frame time into three sub-frame times and three blanking periods, each of the blanking periods following a respective one of the three sub-frame times; during the three sub-frame times, the light emitting diode matrix emitting red, green, and blue light beams, respectively; during at least one of the three blanking periods, the light emitting diode matrix emitting red, green, and blue light beams simultaneously.

Another aspect of a method for driving a liquid crystal display device is provided. The liquid crystal display device comprising a plurality of scanning lines, a plurality of data lines orthogonal to the scanning lines, a scanning driving circuit configured for providing scanning signals to the scanning lines, a data driving circuit configured for providing data signals to the data lines, and a light emitting diode matrix configured for emitting red, green and blue light beams. The method comprising: dividing a frame into three sub-frame times and three blanking periods, each of the blanking periods following a respective one of the three sub-frame times; during a first one of the sub-frame times, turning on the red light emitting diodes in order to display a red sub-image; during a first one of the blanking periods, maintaining the on state of the red light emitting diodes, and turning on the green and blue light emitting diodes in order to provide full-color light beams; during a second one of the sub-frame times, maintaining the on state of the green light emitting diodes in order to display a green sub-image; during a second one of the blanking periods, maintaining the on state of the green light emitting diodes, and turning on the red and blue light emitting diodes in order to provide full-color light beams; during a third one of the sub-frame times, maintaining the on state of the blue light emitting diodes in order to display a blue sub-image; and during a third one of the blanking periods, maintaining the on state of the blue light emitting diodes, and turning on the red and green light emitting diodes in order to provide full-color light beams.

Other novel features and advantages will become more apparent from the following detailed description when taken in conjunction with the accompanying drawings.

### BRIEF DESCRIPTION OF THE DRAWINGS

FIG. 1 is an abbreviated circuit diagram of an LCD device according to a preferred embodiment of the present invention.

FIG. 2 shows timing charts illustrating exemplary operation of the LCD device of FIG. 1.

FIG. 3 is an abbreviated circuit diagram of a conventional LCD device.

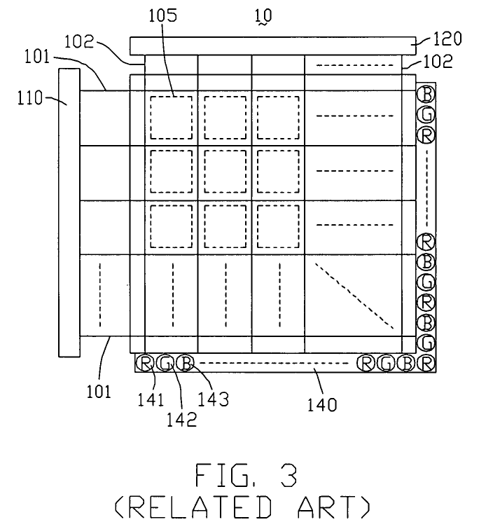

FIG. 4 shows timing charts illustrating operation of the LCD device of FIG. 3.

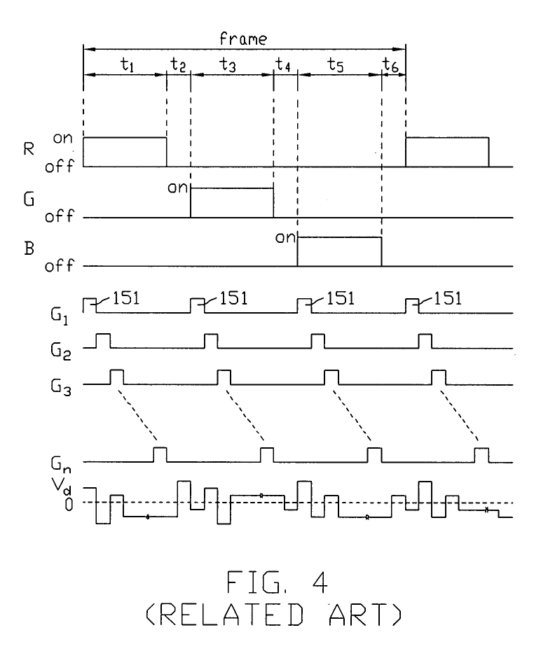

### DETAILED DESCRIPTION OF PREFERRED EMBODIMENTS

Reference will now be made to the drawings to describe preferred and exemplary embodiments of the present invention in detail.

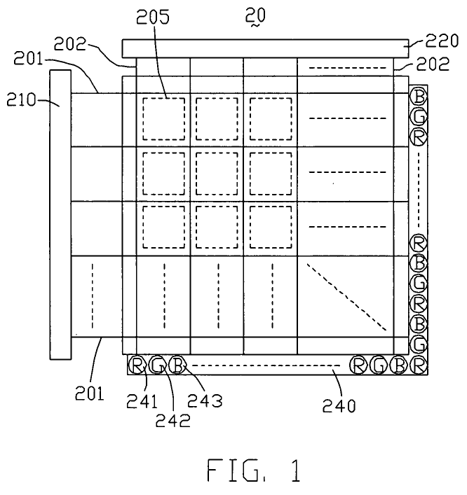

FIG. 1 is an abbreviated circuit diagram of an LCD device according to a preferred embodiment of the present invention. The LCD device 20 includes n rows of parallel scanning lines 201 (where n is a natural number), m columns of parallel data lines 202 orthogonal to the n rows of parallel scanning lines 201 (where m is also a natural number), a plurality of pixels 205 defined by the crossing scanning lines 201 and data lines 202, a scanning driving circuit 210 for providing scanning signals to the scanning lines 201, a data driving circuit 220 for providing data signals to the data lines 202, and an LED matrix 204 for illuminating the LCD device 20.

The LED matrix 204 includes a plurality of red LEDs 241, a plurality of green LEDs 242, and a plurality of blue LEDs 243. The red LEDs 241, the green LEDs 242, and the blue LEDs 243 are alternately arranged in line. A pitch between successive red LEDs 241 is constant. A pitch between successive green LEDs 242 is constant. A pitch between successive blue LEDs 243 is constant.

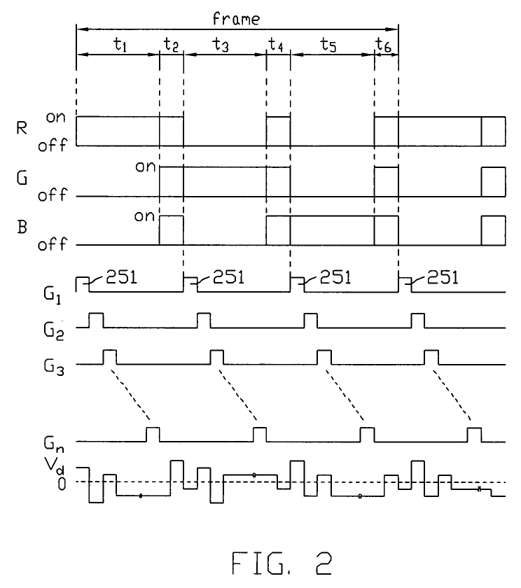

FIG. 2 shows timing charts illustrating exemplary operation of the LCD device 20. Graph (R) illustrates a waveform diagram of voltage supplied to the red LEDs 241. Graph (G) illustrates a waveform diagram of voltage supplied to the green LEDs 242. Graph (B) illustrates a waveform diagram of voltage supplied to the blue LEDs 243. Graphs (G₁-Gₙ) illustrate waveform diagrams of voltage supplied to the scanning lines 201. Graph (V_{d}) illustrates a waveform diagram of gradation voltage corresponding to the image data supplied to the data lines 202. A period for displaying a full-color image is defined as a frame time.

The exemplary operation of the LCD device 20 includes the following steps:

a. a frame time is divided into three sub-frame times t₁, t₃, and t₅, and three blanking periods t2, t4, and t6. Each of the blanking periods t₂, t₄, and t₆ follows one of the three sub-frame times t1, t3, and t5, respectively.

b. during the first sub-frame time t1, a voltage pulse “on” is provided to the red LEDs 241 of the LED matrix 240, so that the red LEDs 241 are turned on and start emitting red light beams for image display.

c. when the red LEDs 241 are turned on, the scanning driving circuit 210 sequentially provides a plurality of scanning signals 251 to the scanning lines 201 to enable the pixels 205 to receive data signals.

d. when the scanning lines 201 are scanned, the data driving circuit 220 outputs the gradation voltage V_{d} to the data lines 202, and then the pixels 205 receive data signals from corresponding data lines 202 to cooperatively display a red sub-image.

e. during the first blanking period t2, voltage pulses “on” are provided to the red LEDs 241, the green LEDs 242, and the blue LEDs 243 simultaneously. Therefore the red LEDs 241, the green LEDs 242, and the blue LEDs 243 are turned on and start emitting red, green and blue light beams simultaneously, thereby cooperatively providing ample full-color light beams. Simultaneously, no scanning signals or data signals are applied to the scanning lines 201 or the data lines 202. Accordingly, the pixels 205 discharge electricity so as to eliminate any residual image phenomenon.

f. during the second sub-frame time t3, the voltage pulse “on” provided to the green LEDs 242 of the LED matrix 240 continues, so that the green LEDs 242 emit green light beams for image display.

g. steps “c” through “e” are repeated in respect of the green LEDs 242, in order to display a green sub-image during the second sub-frame time t3 and provide ample full-color light beams during the second blanking period t4.

h. during the third sub-frame time t₅, the voltage pulse “on” provided to the blue LEDs 243 of the LED matrix 240 continues, so that the blue LEDs 243 emit blue light beams for image display.

i. steps “c” through “e” are repeated in respect of the blue LEDs 243, in order to display a blue sub-image during the third sub-frame time t5 and provide ample full-color light beams during the third blanking period t6. Then the red sub-image, the green sub-image, and the blue sub-image mix and form a full-color image, as perceived by a human viewer.

j. in a next frame time, steps “a” through “i” are repeated.

The frame time in the driving method may for example be 16.7 ms, in order to provide an acceptable refresh rate for images displayed by the LCD device 20. The white balance of the LCD device 20 can be adjusted by changing the ratio of the first sub-frame time t1 relative to the second sub-frame time t3, and/or by changing the ratio of the first sub-frame time t1 relative to the third sub-frame time t5. The ratio of each sub-frame time t1, t3, and t5 to the corresponding following blanking period t2, t4, and t6 may be in the range of from 10/1 to 5/1. The periods of the first sub-frame time t1, the second sub-frame time t3, and the third sub-frame time t5 may be equal to each other. The periods of the first blanking period t2, the second blanking period t4, and the third blanking period t6 may be equal to each other.

In the method for driving the LCD device 20, the red LEDs 241, the green LEDs 242, and the blue LEDs 243 emit light beams at the same time during each of the blanking periods t2, t4, and t6. With this process, the brightness of images displayed by the LCD device 2 is enhanced without any need to increase the number of LEDs 241, 242, 243 of the LED matrix 240.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. A method for driving a liquid crystal display device, the liquid crystal display device comprising a plurality of scanning lines, a plurality of data lines orthogonal to the scanning lines, a scanning driving circuit configured for providing scanning signals to the scanning lines, a data driving circuit configured for providing data signals to the data lines, and a light emitting diode matrix configured for emitting red, green and blue light beams, the method comprising:
dividing a frame time into three sub-frame times and three blanking periods, each of the blanking periods following a respective one of the three sub-frame times;
during the three sub-frame times, the light emitting diode matrix emitting red, green, and blue light beams, respectively;
during at least one of the three blanking periods, the light emitting diode matrix emitting red, green, and blue light beams simultaneously.

2. The method as claimed in claim 1, wherein during each sub-frame time, the scanning driving circuit generates a plurality of scanning signals and sequentially provides the scanning signals to the scanning lines.

3. The method as claimed in claim 2, wherein during each sub-frame time, the data driving circuit provides a plurality of gradation voltages to the data lines when the scanning lines are scanned.

4. The method as claimed in claim 1, wherein during each of the three blanking periods, the light emitting diode matrix emits red, green, and blue light beams simultaneously.

5. The method as claimed in claim 1, wherein a white balance of the liquid crystal display device is proportional to a ratio of a first one of the sub-frame times to a second one of the sub-frame times, and proportional to a ratio of the first sub-frame time to a third one of the sub-frame times.

6. The method as claimed in claim 1, wherein the three sub-frame times are equal to each other.

7. The method as claimed in claim 1, wherein the three blanking periods are equal to each other.

8. The method as claimed in claim 1, wherein a ratio of each sub-frame time to the following blanking period is in the range of from 10/1 to 5/1.

9. The method as claimed in claim 1, wherein each of the frame times is approximately 16.7 ms.

10. The method as claimed in claim 1, wherein the light emitting diode matrix comprises a plurality of red light emitting diodes, a plurality of green light emitting diodes, and a plurality of blue light emitting diodes.

11. The method as claimed in claim 10, wherein the red light emitting diodes, the green light emitting diodes, and the blue light emitting diodes are alternately arranged in a line at a periphery of the liquid crystal display device, and a pitch between adjacent of the red, green, and blue light emitting diodes is constant.

12. A method for driving a liquid crystal display device, the liquid crystal display device comprising a plurality of scanning lines, a plurality of data lines orthogonal to the scanning lines, a scanning driving circuit configured for providing scanning signals to the scanning lines, a data driving circuit configured for providing data signals to the data lines, and a light emitting diode matrix configured for emitting red, green and blue light beams, the method comprising:
a. dividing a frame into three sub-frame times and three blanking periods, each of the blanking periods following a respective one of the three sub-frame times;
b. during a first one of the sub-frame times, turning on the red light emitting diodes in order to display a red sub-image;
c. during a first one of the blanking periods, maintaining the on state of the red light emitting diodes, and turning on the green and blue light emitting diodes in order to provide full-color light beams;
d. during a second one of the sub-frame times, maintaining the on state of the green light emitting diodes in order to display a green sub-image;
e. during a second one of the blanking periods, maintaining the on state of the green light emitting diodes, and turning on the red and blue light emitting diodes in order to provide full-color light beams;
f. during a third one of the sub-frame times, maintaining the on state of the blue light emitting diodes in order to display a blue sub-image; and
g. during a third one of the blanking periods, maintaining the on state of the blue light emitting diodes, and turning on the red and green light emitting diodes in order to provide full-color light beams.

13. The method as claimed in claim 12, wherein during each of the sub-frame times, the scanning driving circuit generates a plurality of scanning signals and sequentially supplies the scanning signals to the scanning lines.

14. The method as claimed in claim 13, wherein during each of the sub-frame times, the data driving circuit provides a plurality of gradation voltages to the data lines when the scanning lines are scanned.

15. The method as claimed in claim 12, wherein a white balance of the liquid crystal display device is proportional to a ratio of a first one of the sub-frame times to a second one of the sub-frame times, and proportional to a ratio of the first sub-frame time to a third one of the sub-frame times.
